(19) United States
(12) Patent Application Publication
(10) Pub. No.: US 2016/0258561 A1
(43) Pub. Date: Sep. 8, 2016

(54) CONNECTOR MEMBER FOR CONNECTING PIPE LINE BLOCKS AND METHOD FOR MANUFACTURING THE SAME

(71) Applicant: TIGERS POLYMER CORPORATION, Osaka (JP)

(72) Inventor: Kiyofumi HIROI, Hyogo (JP)

(21) Appl. No.: 14/751,802

(22) Filed: Jun. 26, 2015

(30) Foreign Application Priority Data
Mar. 2, 2015 (JP) 2015-039839

(51) Int. Cl. F16L 21/02

(52) U.S. Cl. CPC F16L 21/02

(57) ABSTRACT

A connector member for connecting pipe line blocks according to an embodiment of this disclosure includes a hollow pipe-shaped portion made of a synthetic resin, and an O-ring. The pipe-shaped portion has a ring-shaped seal groove on an outer peripheral surface of the pipe-shaped portion, and an inclined surface having a conical surface shape on a side close to a pipe end from the seal groove on the outer peripheral surface, a diameter of the inclined surface being reduced toward the pipe end. The O-ring is attached to the seal groove. D2 representing a diameter of a cylindrical portion defined by a bottom surface of the seal groove and D3 representing an inner diameter of the O-ring with no load satisfy a relationship of D2>D3. D1 representing an outer diameter at the pipe end of the pipe-shaped portion and D2 satisfy a relationship of D1<D2.

### CROSS-REFERENCE TO RELATED APPLICATION

This application is based on Japanese Patent Application No. 2015-039839 filed with the Japan Patent Office on Mar. 2, 2015, the entire content of which is hereby incorporated by reference.

### BACKGROUND

1. Technical Field

This disclosure relates to a connector member for connecting pipe line blocks and a method for manufacturing the same.

2. Related Art

A technique for disposing pipe line blocks, each of which includes a pipe line therein, to face each other and connecting the pipe lines provided in the respective pipe line blocks to each other so as to form a continuous pipe line, has been used to form a hydraulic pressure circuit, a fluid supply circuit, or the like. For example, such a connection structure of the pipe line blocks and the pipe lines has been adopted to form a hydraulic pressure circuit for an automatic transmission of an automobile, a refrigerant circulation circuit for an air conditioner, or the like.

When the pipe lines are connected between the pipe line blocks, a pipe-shaped connector member, to which an O-ring is attached, is interposed between the pipe line blocks in order to facilitate connection operation and ensure sealing performance.

For example, JP-A-2005-207463 discloses a technique that is useful when lines (an outlet and a connection port) respectively provided in a liquid tank and a double pipe joint block to be coupled together are connected to each other. According to this technique, connecting pipe portions at both ends of a pipe joint (a connector member), which has a flange portion on an outer periphery of an intermediate portion in a longitudinal direction, are inserted into opening ends of the respective lines with O-rings. Furthermore, the flange portion is housed in an annular housing depressed portion provided in the block and held between joining surfaces of the liquid tank and the double pipe joint block. This patent publication discloses that, according to the connector member and the connection structure, cost can be cut by using a member having a simple configuration.

In addition, JP-A-2014-151471 discloses a connector member that has an O-ring attached to a seal groove and that can be used to connect pipe line blocks.

### SUMMARY

A connector member for connecting pipe line blocks according to an embodiment of this disclosure includes a hollow pipe-shaped portion made of a synthetic resin, and an O-ring. The pipe-shaped portion has a ring-shaped seal groove on an outer peripheral surface of the pipe-shaped portion, and an inclined surface having a conical surface shape on a side close to a pipe end from the seal groove on the outer peripheral surface, a diameter of the inclined surface being reduced toward the pipe end. The O-ring is attached to the seal groove. D2 representing a diameter of a cylindrical portion defined by a bottom surface of the seal groove and D3 representing an inner diameter of the O-ring with no load satisfy a relationship of D2>D3. D1 representing an outer diameter at the pipe end of the pipe-shaped portion and D2 satisfy a relationship of D1<D2.

### BRIEF DESCRIPTION OF DRAWINGS

FIG. 1 is a partial cross-sectional view illustrating a connector member according to a first embodiment of this disclosure;

FIG. 2 is a partial cross-sectional view illustrating a pipe-shaped portion provided in the connector member according to the first embodiment of this disclosure;

FIG. 3 is a view illustrating a shape of an O-ring before being attached;

FIGS. 4A to C are views illustrating a process for attaching the O-ring to the pipe-shaped portion;

FIGS. 5A to B are cross-sectional views illustrating a process where pipe lines of pipe line blocks are connected by the connector member according to the first embodiment of this disclosure; and

FIG. 6 is a partial cross-sectional view illustrating a connector member according to a third embodiment of this disclosure.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The connector member disclosed in JP-A-2005-207463 does not include a seal groove. Such a connector member has a problem that it is difficult to accurately define a position of the O-ring. Sealing may be insufficient when the O-ring is displaced or when the O-ring is obliquely attached.

In the connector member disclosed in JP-A-2014-151471, the O-ring is attached to the seal groove. Accordingly, the posture and position of the O-ring are accurately defined. When the O-ring is attached to the seal groove, however, the O-ring needs to be stretched once in order to be fitted to the seal groove. Thus, an attachment operation is complicated.

For example, the connector member disclosed in JP-A-2014-151471 is manufactured by operation in which one end of the O-ring is hooked by the seal groove of the connector member and the rest of the O-ring is fitted to the seal groove while the O-ring is stretched. However, such operation requires skills. Accordingly, the efficiency of the O-ring attachment is low. In addition, when such an attaching method is employed, the attached O-ring may be twisted or a part of the O-ring may be stretched more intensively than the rest during the attachment, and thus sealing by the O-ring may be insufficient.

Meanwhile, an O-ring attachment tool or an O-ring attachment jig may be used, which is designed to allow the attachment of the O-ring to the seal groove by increasing the diameter thereof. However, additional operation is required to attach the tool or the jig to the connector member or the O-ring, or to remove the jig after the O-ring is attached to the connector member. Thus, the efficiency of the O-ring attachment tends to be degraded.

An object of this disclosure is to provide a connector member for connecting pipe line blocks that allows efficient O-ring attachment operation and appropriate O-ring attachment, and a method for manufacturing the same.

The inventor has found as a result of earnest studies that the above object is achieved when an inclined surface having a conical surface shape of a particular mode is provided on a side of an outer peripheral surface of a pipe-shaped portion that is close to a pipe end from a seal groove and further D1 representing an outer diameter at the pipe end of the connector member and D2 representing a diameter of a bottom surface of the seal groove satisfy a relationship of D1<D2. The inventor has then completed the connector member for connecting pipe line blocks of this disclosure.

A connector member for connecting pipe line blocks according to an embodiment of this disclosure includes a hollow pipe-shaped portion made of a synthetic resin, and an O-ring. The pipe-shaped portion has a ring-shaped seal groove on an outer peripheral surface of the pipe-shaped portion, and an inclined surface having a conical surface shape on a side close to a pipe end from the seal groove on the outer peripheral surface, a diameter of the inclined surface being reduced toward the pipe end. The O-ring is attached to the seal groove. D2 representing a diameter of a cylindrical portion defined by a bottom surface of the seal groove and D3 representing an inner diameter of the O-ring with no load satisfy a relationship of D2>D3. D1 representing an outer diameter at the pipe end of the pipe-shaped portion and D2 satisfy a relationship of D1<D2. (first embodiment)

In the connector member according to the first embodiment of this disclosure, a relationship of D1<D3 may further be satisfied (second embodiment). In addition, in the connector member according to the first embodiment, a small-diameter cylindrical portion that has a substantially cylindrical outer peripheral surface shape may be formed on the side close to a pipe end from the inclined surface having the conical surface shape of the pipe-shaped portion (third embodiment).

A method for manufacturing the connector member for connecting pipe line blocks according to the first to third embodiments includes: forming the connector member including the hollow pipe-shaped portion by injection molding of the synthetic resin; preparing the O-ring; adjusting a posture of the O-ring by bringing an inner peripheral surface of the O-ring into contact with the inclined surface such that the O-ring is orthogonal to a center axis of the pipe-shaped portion; and pushing the O-ring toward the seal groove while the posture is maintained, moving the O-ring to the seal groove while a diameter of the O-ring is increased, and attaching the O-ring to the seal groove (fourth embodiment).

A method for manufacturing a connector member for connecting pipe line blocks according to an embodiment of this disclosure includes: forming a connector member including a hollow pipe-shaped portion by injection molding of a synthetic resin; preparing an O-ring, wherein the pipe-shaped portion has a ring-shaped seal groove on an outer peripheral surface of the pipe-shaped portion, and an inclined surface having a conical surface shape on a side close to a pipe end from the seal groove on the outer peripheral surface, a diameter of the inclined surface being reduced toward the pipe end; adjusting a posture of the O-ring by bringing an inner peripheral surface of the O-ring into contact with the inclined surface such that the O-ring is orthogonal to a center axis of the pipe-shaped portion; and pushing the O-ring toward the seal groove while the posture is maintained, moving the O-ring to the seal groove while a diameter of the O-ring is increased, and attaching the O-ring to the seal groove (fifth embodiment).

In the method for manufacturing a connector member for connecting pipe line blocks according to the fifth embodiment, D2 representing a diameter of a cylindrical portion defined by a bottom surface of the seal groove and D3 representing an inner diameter of the O-ring with no load may satisfy a relationship of D2>D3, and D1 representing an outer diameter at the pipe end of the pipe-shaped portion and D2 may satisfy D1<D2 (sixth embodiment).

In the method for manufacturing a connector member for connecting pipe line blocks according to the sixth embodiment, D1 and D3 may satisfy a relationship of D1<D3 (seventh embodiment).

According to the connector member for connecting pipe line blocks according to the embodiments of this disclosure (the first to third embodiments) and the method for manufacturing the connector member for connecting pipe line blocks according to the embodiments of this disclosure (the fourth to seventh embodiments), the O-ring attachment operation to the connector member is further efficiently performed. In addition, twisting, partial stretching, and the like of the O-ring are less likely to occur. Thus, the O-ring is appropriately attached.

Furthermore, in the connector member for connecting according to the second embodiment, the posture of the O-ring can be adjusted by bringing the O-ring into contact with the inclined surface without stretching the O-ring. Thus, the attachment operation becomes further efficient. Moreover, in the connector member for connecting according to the third embodiment, the posture of the O-ring can be adjusted by both of the inclined surface and the small-diameter cylindrical portion. Thus, the stability and efficiency of the attachment operation are improved.

Embodiments of this disclosure will be described with an exemplary connector member used to connect pipe line blocks used for a hydraulic pressure circuit for an automatic transmission of an automobile with reference to the accompanying drawings. The embodiments of this disclosure are not limited to the embodiment described below. Various modifications can be made to the embodiment described below.

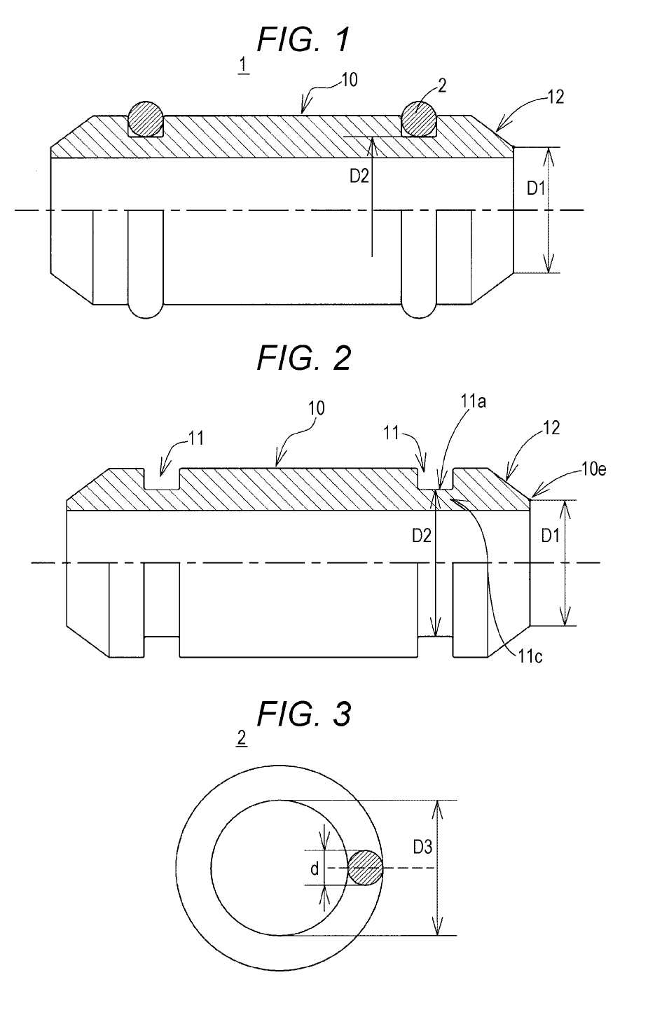

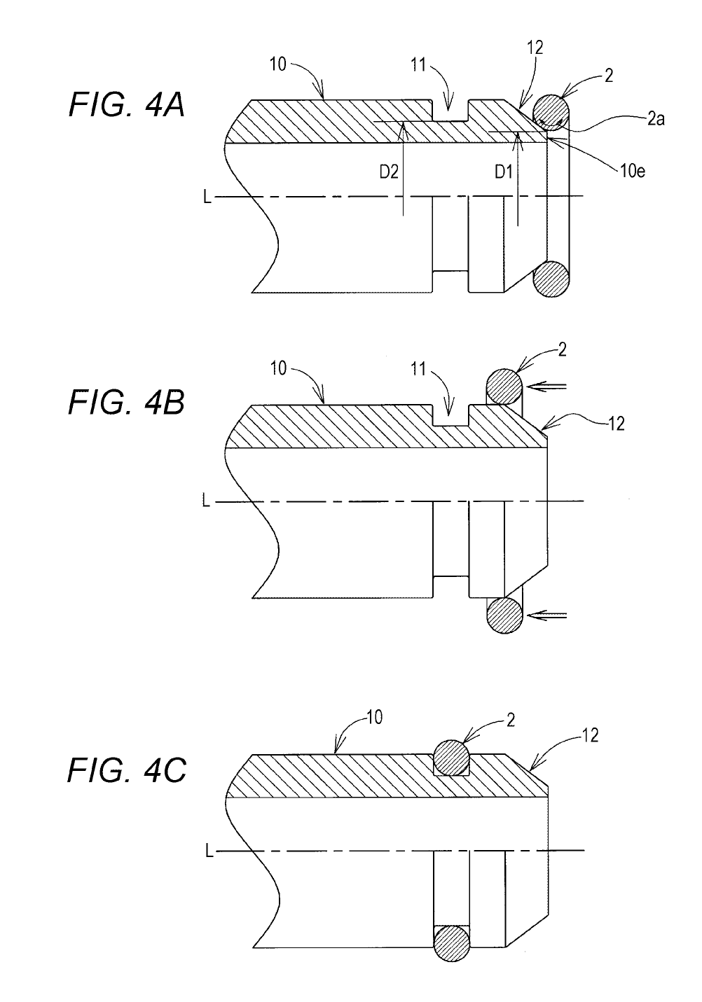

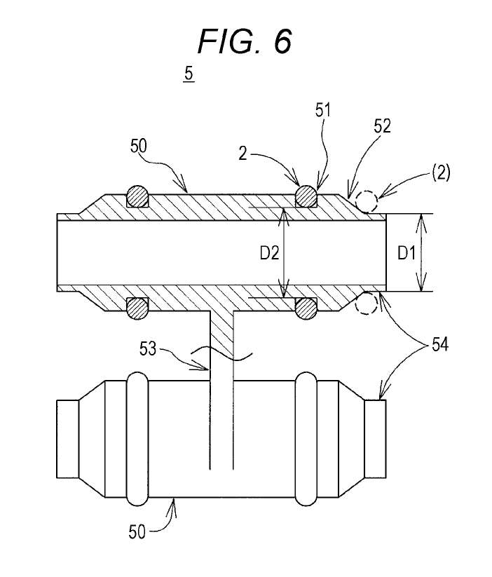

FIG. 1 depicts a connector member 1 according to a first embodiment of this disclosure. The cross-sectional view of the connector member 1 is illustrated at the upper half of FIG. 1, while the external view of the connector member 1 is illustrated at the lower half of FIG. 1. In FIG. 2, FIG. 4, and FIG. 6, a cross-sectional view and an external view are similarly illustrated. The connector member 1 is made of a synthetic resin and formed in a straight pipe shape with a cylindrical cross section. In other words, the connector member 1 includes a hollow pipe-shaped portion 10. In this embodiment, the connector member 1 is substantially formed of the pipe-shaped portion 10. An O-ring 2 for sealing is attached to the connector member 1.

FIG. 2 depicts the connector member before the O-ring is attached thereto. Seal grooves 11 and 11 are provided near both ends in a pipe longitudinal direction on an outer peripheral surface of the pipe-shaped portion 10 of the connection member 1. In this embodiment, the seal grooves 11 and 11 are formed as two ring-shaped grooves, each of which has a groove cross section of a substantially rectangular shape. The O-ring 2, which will be described below, is attached to this seal groove 11. A gap between the connector member 1 and an inner peripheral surface of a pipe line is sealed by the O-ring 2.

FIG. 3 depicts the shape of the O-ring 2. The O-ring is a ring-shaped sealing member that has a circular cross section with a diameter d. The O-ring is formed in an annular shape by a material having elasticity such as rubber or any of various types of elastomer. An inner diameter of the O-ring 2 that is before being attached to the connector member and is in a state with no load being applied thereto (hereinafter, appropriately referred to as an “inner diameter of the O-ring with no load”) is indicated by D3. In this embodiment, a cross-sectional shape of the O-ring is a circle with the diameter d. However, the O-ring may have another cross-sectional shape such as a rectangular cross-sectional shape.

The shape of the connector member 1 will be described in further detail.

A bottom surface 11a of the seal groove 11 that is provided in the pipe-shaped portion 10 of the connector member 1 has a cylindrical outer peripheral surface shape. The diameter of this cylinder is indicated by D2. In other words, the bottom surface 11a is formed on the outer peripheral surface of the pipe-shaped portion 10 so as to define a cylindrical portion 11c with the diameter D2. Sealing is made when the bottom surface 11a comes into contact with an inner-most peripheral portion of the O-ring 2. The dimensions of the O-ring 2 and the seal groove 11 are determined such that D2 representing the diameter of the cylindrical portion defined by the bottom surface of the seal groove and D3 representing the inner diameter of the O-ring 2 with no load before being attached satisfy a relationship of D2>D3.

An inclined surface 12 having a conical surface shape, a diameter of which is reduced toward the pipe end 10e, is provided on side of the outer peripheral surface of the pipe-shaped portion 10 that is close to a pipe end 10e from the seal groove 11 in a pipe axial direction. Then, as illustrated in FIG. 4A, a surface 2a in an inner peripheral portion of the O-ring that is before being attached to the pipe-shaped portion 10 and is hardly applied with the load can come into contact with the inclined surface 12 having the conical surface shape. In this embodiment, the inclined surface 12 is formed as the conical surface so as to appear as a straight line on cross section of the pipe-shaped portion 10 that includes the center axis of the pipe-shaped portion 10. However, the shape of the inclined surface 12 may be provided to appear as an outwardly projected curve or an inwardly projected curve on cross section of the pipe-shaped portion 10 that includes the center axis of the pipe-shaped portion 10, for example.

D1 representing an outer diameter at the pipe end 10e of the pipe-shaped portion 10 and D2 representing the diameter of the cylindrical portion that is defined by the bottom surface of the seal groove satisfy a relationship of D1<D2. In other words, the outer diameter of the pipe-shaped portion 10 at the pipe end 10e is set to be smaller than the diameter of the bottom surface of the seal groove 11.

Furthermore, in this embodiment, the outer diameter D1 of the pipe-shaped portion 10 at the pipe end 10e and the inner diameter D3 of the O-ring 2 with no load before being attached may satisfy a relationship of D1<D3 (second embodiment). However, this relationship may not be satisfied.

The pipe-shaped portion 10 of the connector member is formed by injection molding of a synthetic resin. The synthetic resin for forming the pipe-shaped portion 10 is not particularly limited as long as it is a resin that can be molded by injection molding. As the synthetic resin, a thermoplastic resin such as an olefin-based resin like a polypropylene resin, a polyamide resin, and an acrylonitrile-butadiene-styrene resin; a thermosetting resin such as a melamine resin; a rubber; and a thermoplastic elastomer can be used. The pipe-shaped portion 10 of the connector member 1 according to this embodiment is formed by a polyamide resin.

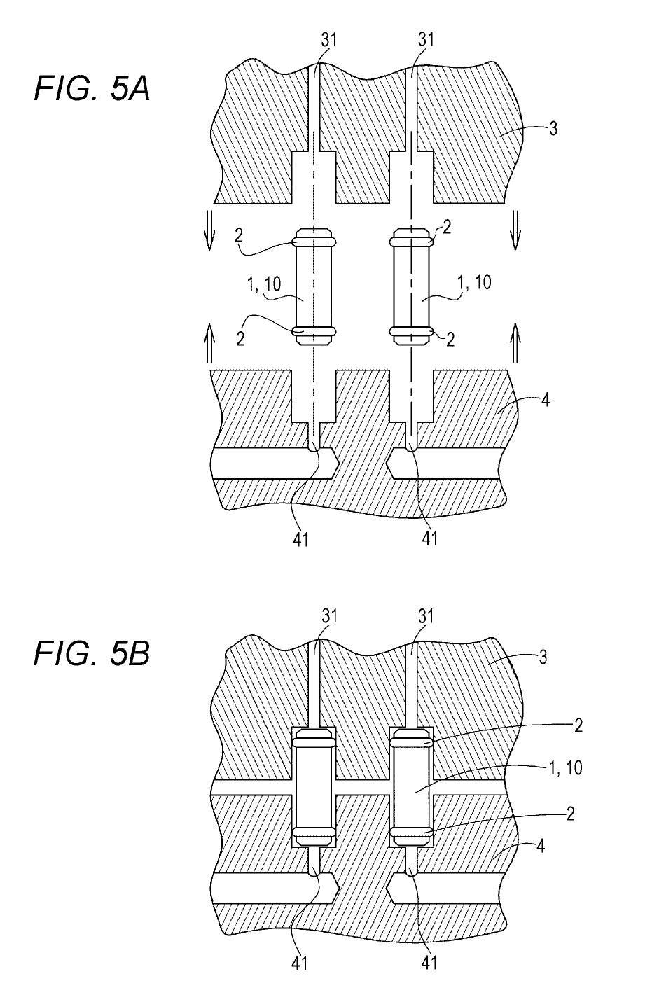

A process where pipe lines of pipe line blocks that constitute the hydraulic pressure circuit are connected by the connector member 1 will be described with reference to FIGS. 5A and B. In FIGS. 5A to B, a cross section of a part of the pipe line blocks and an external appearance of the connector member 1 are illustrated. Here, the pipe line block is a member that has a pipe line formed therein. This member is configured such that, when specified pipe line blocks are disposed to face each other with a specified positional relationship, the pipe lines therein communicate with each other to complete a continuous pipe line. The pipe line block is typically made of an iron-based alloy, an aluminum alloy, or a synthetic resin. The pipe line block may include plural pipe lines. These pipe lines are typically formed by machining.

The connector member 1 is interposed between pipe line blocks 3 and 4, which are disposed to face each other, to connect pipe lines 31 and 41. In this embodiment, the pipe line block 3 on a pressure control valve side and the pipe line block 4 on a piping side are assembled. The pipe lines 31 and 41 are respectively provided on inner sides of the pipe line blocks by boring. As illustrated in FIG. 5A, the connector members 1 and 1 are positioned to enter the pipe lines 31 and 41, respectively. When the pipe line blocks 3 and 4 are disposed to face each other and assembled, the pipe lines 31 and 41 at mutually facing positions are connected through the connector member 1.

When both ends of the pipe-shaped portion 10 of the connector member, which has the sealing members (the O-rings) 2 and 2 attached to the seal grooves 11 and 11, are respectively inserted into the pipe lines 31 and 41, the connector member 1 connects these pipe lines (FIG. 5B). In other words, gaps between the outer peripheral surfaces of the pipe-shaped portion 10 of the connector member and the inner peripheral surfaces of the pipe lines 31 and 41 are sealed by the sealing members (the O-rings) 2 and 2.

In this embodiment, the pipe lines 31 and 41 provided in the pipe line blocks 3 and 4 each form a step shape near the end surfaces of the pipe line blocks. This step shape is formed to prevent the inserted connector member 1 from entering one of the pipe lines excessively deeply. The pipe line may have a straight pipe shape instead of the step shape as long as the connector member 1 is prevented from entering the pipe line excessively deeply. FIG. 5B depicts the pipe line blocks 3 and 4 that are assembled such that a small clearance remains between the pipe line blocks 3 and 4. However, the pipe line blocks 3 and 4 may be assembled such that facing surfaces of the pipe line blocks are brought into close contact with each other.

A method for manufacturing the connector member 1 will be described.

First, prior to attachment of the O-ring, the connector member (the pipe-shaped portion 10) itself is manufactured (first process). The connector member is formed by injection molding of a synthetic resin. The connector member includes the hollow pipe-shaped portion 10. The ring-shaped seal groove 11 is provided on the outer peripheral surface of the pipe-shaped portion 10. The inclined surface 12 having the conical surface shape, the diameter of which is reduced toward the pipe end 10e, is provided on the side of the outer peripheral surface of the pipe-shaped portion 10 that is close to the pipe end 10e from the seal groove 11. An injection molding die is prepared such that the connector member has such a shape. The injection molding of the synthetic resin is performed by using the die, and accordingly, the connector member, to which the O-ring is not yet attached, is manufactured.

It should be noted that additional operation for forming a part of the connector member by cutting operation or the like may be included in this injection molding process for the connector member. For example, grinding operation for removing a gate mark formed during injection molding or cutting operation for refining the shape of the inclined surface 12 may be performed as the additional operation.

The O-ring 2 is prepared (second process). The O-ring 2 may be formed in a specified shape by injection molding. Alternatively, the O-ring may be manufactured by adhering both ends of a string-like material that is cut to have a specified length and has a specified cross section so as to form a ring.

The O-ring 2 is attached to the connector member through the following process. FIGS. 4A to C depict the O-ring attachment process. In FIGS. 4A to 4C, the cross-sectional view of the pipe-shaped portion 10 of the connector member is illustrated at the upper half, while the external view of the pipe-shaped portion 10 of the connector member is illustrated at the lower half. The cross-sectional view of the O-ring 2 is also illustrated in FIGS. 4A to 4C.

First, prior to insertion, the posture of the O-ring 2 is adjusted (third process). As illustrated in FIG. 4A, the O-ring 2 is positioned at the pipe end 10e of the pipe-shaped portion 10 of the connector member. At this time, the surface 2a in the inner peripheral portion of the O-ring 2 comes into contact with the inclined surface 12 having the conical surface shape of the pipe-shaped portion 10 of the connector member. During contact, the O-ring 2 can be brought into contact with the inclined surface 12 in a state that the O-ring 2 is hardly applied with a load such that the O-ring 2 is not substantially stretched. Then, the posture of the O-ring 2 is adjusted such that the O-ring 2 is orthogonal to the center axis L of the pipe-shaped portion 10. In other words, the posture of the O-ring 2 is adjusted such that the O-ring 2 is located on a plane that is parallel to a plane orthogonal to the center axis L, and accordingly, the O-ring 2 is positioned at the end of the pipe-shaped portion 10 by using the inclined surface 12.

Following the O-ring posture adjustment process (third process), the O-ring 2 is moved and attached to the seal groove 11 (fourth process). As illustrated in FIG. 4B, the O-ring 2 is pushed toward the seal groove 11 while the posture of the O-ring 2 with respect to the center axis L of the pipe-shaped portion 10 is maintained. At the same time that the O-ring 2 is pushed, the diameter of the O-ring 2 is increased by using the inclined surface 12. By action of the inclined surface 12 having the conical surface shape, the diameter of the O-ring 2 is increased while the O-ring 2 is uniformly stretched in the peripheral direction. Then, the O-ring 2 is moved to the seal groove. At this time, the diameter of the O-ring 2 is reduced due to elasticity, and the O-ring 2 is attached to the seal groove 11 (FIG. 4C).

The connector member 1, to which the O-ring 2 is attached, can be manufactured by the above processes.

The above-described third process and fourth process may be manually performed. However, the third process and the fourth process can be also performed by an automatic machine.

From a perspective of smoothly increasing the diameter of the O-ring and pushing the O-ring in the fourth process, an angle defined by the inclined surface 12 and the center axis of the pipe-shaped portion in cross section that includes the center axis of the pipe-shaped portion may be 45 degrees or smaller, and particularly 35 degrees or smaller.

Actions and effects of the connector member for connecting pipe line blocks and the method for manufacturing the same according to the embodiment of this disclosure will be described.

Since the O-ring 2 is attached to the connector member 1 for connecting pipe line blocks according to the above-described embodiment, the pipe line blocks can be easily connected. In addition, the O-ring 2 is attached to the seal groove 11. Thus, the O-ring is not displaced when the connector member is inserted into the pipe line of the pipe line block. From a perspective of further reliably suppressing the displacement of the O-ring, the depth of the seal groove (the depth of the groove in the radial direction of the pipe-shaped portion) may be at least a half of the diameter d (d/2) in cross section of the O-ring.

In addition, D2 representing the diameter of the bottom surface of the seal groove and D3 representing the inner diameter of the O-ring with no load before being attached satisfy the relationship of D2>D3. Accordingly, the inner peripheral surface of the O-ring 2 comes in close contact with the bottom surface 11a of the seal groove 11. Thus, the O-ring and the seal groove are further reliably sealed.

In addition, in the connector member for connecting pipe line blocks according to the above-described embodiment, the inclined surface 12 having the conical surface shape, the diameter of which is reduced toward the pipe end 10e, is provided on the side of the outer peripheral surface of the pipe-shaped portion 10 that is close to the pipe end 10e from the seal groove 11. The surface 2a in the inner peripheral portion of the O-ring that is before being attached to the pipe-shaped portion 10 and is hardly applied with the load can come into contact with the inclined surface 12 having the conical surface shape. Furthermore, the outer diameter D1 at the pipe end 10e of the pipe-shaped portion and the diameter D2 of the cylindrical portion defined by the bottom surface of the seal groove 11 satisfy the relationship of D1<D2. Accordingly, when the O-ring 2 is attached to the connector member, the O-ring 2 can be positioned at the pipe end 10e to assume a specified posture (the posture orthogonal to the center axis L) with the O-ring 2 being hardly deformed. Therefore, the subsequent O-ring attachment can be facilitated. In other words, the above-described connector member for connecting pipe line blocks can be efficiently manufactured by the above-described manufacturing method.

Upon attachment of the O-ring, after the O-ring 2, which adopts the specified posture by the third process, is prepared, the O-ring 2 is moved to the seal groove while the specified posture is maintained in the fourth process. In this way, twisting of the O-ring during the attachment is suppressed. In addition, a state that a part of the O-ring is stretched compared to the rest is suppressed. Accordingly, the O-ring 2 is appropriately attached to the seal groove without being accompanied by twisting or non-uniform stretching. The appropriate attachment of the O-ring contributes to improvement of the sealing performance by the O-ring.

In order to make the O-ring attachment process further efficient and appropriate, the friction between the O-ring 2 and the inclined surface 12 may be reduced. For example, when lubricant oil is applied on a surface of the O-ring or the inclined surface 12 and the third process and the fourth process are then performed, the O-ring attachment process can be performed further efficiently and the O-ring can be further appropriately attached.

Furthermore, when the outer diameter D1 at the pipe end 10e of the pipe-shaped portion and the inner diameter D3 of the O-ring with no load before being attached to the pipe-shaped portion 10 satisfy the relationship of D1<D3, the O-ring is reliably and easily brought into contact with the inclined surface 12 without being deformed in the third process for adjusting the posture of the O-ring 2. Accordingly, the efficiency of insertion operation is further increased. In addition, the load that causes stretching of the O-ring 2 is hardly applied to the O-ring in the O-ring posture adjustment process (third process). Thus, the occurrence of the non-uniform stretching and deformation in the peripheral direction of the O-ring is further reliably suppressed when the O-ring is attached. Therefore, the satisfaction of the relationship D1<D3 also contributes to the improvement of the sealing performance.

Embodiments of this disclosure are not limited to the above embodiment. Various modifications can be added to the embodiments of this disclosure. Other embodiments of this disclosure will be described below. In the following description, however, parts that differ from the above embodiment will be mainly described. The detailed description on the same parts as the above description will be omitted. In addition, parts of the embodiments described below can be combined. Alternatively, a part of one embodiment can be replaced with a part of another embodiment.

FIG. 6 depicts a connector member 5 according to a third embodiment of this disclosure. In this embodiment, two pipe-shaped portions 50 and 50 and a coupling portion 53 are integrally molded such that the pipe-shaped portions 50 and 50 arranged in parallel are coupled by the plate-shaped coupling portion 53 located therebetween. Seal grooves 51 and 51 are respectively provided in the pipe-shaped portions 50 and 50. The O-rings 2 and 2 are respectively attached to the seal grooves 51 and 51. The connector member may include the plural pipe-shaped portions in such a manner. For example, if the connector member that includes two, three, or four pipe-shaped portions is used, two, three, or four pipe lines can be simultaneously connected. Thus, connection operation becomes efficient.

In addition, in this embodiment, the plate-shaped coupling portion 53 is formed near the central portion in the longitudinal direction of the pipe-shaped portion 50 of the connector member 5. Like the connector member disclosed in JP-A-2005-207463, this coupling portion 53 fulfills a function of determining the depth of insertion of the connector member 5 in the longitudinal direction of the pipe line.

In this embodiment, similarly to the first embodiment, an inclined surface 52 having a conical surface shape is provided on a part of the outer peripheral surface of the pipe-shaped portion that is near the pipe end from the seal groove 51. In addition, similarly to the first embodiment, the outer diameter D1 at the pipe end of the pipe-shaped portion, the diameter D2 of the bottom surface of the seal groove, and the inner diameter D3 of the O-ring with no load before being attached are set such that D1, D2, and D3 satisfy the relationship of D2>D3 and the relationship of D1<D2. Thus, in this embodiment, the same advantageous effects as those in the first embodiment can be obtained.

Furthermore, in this embodiment, a small-diameter cylindrical portion 54 that has a substantially cylindrical outer peripheral surface shape is formed on the pipe end side from the inclined surface 52 having the conical surface shape. The small-diameter cylindrical portion 54 may be formed to be adjacent to the inclined surface 52 having the conical surface shape, to be located at the pipe end, and to have the same outer diameter as the outer diameter D1 at the pipe end. The outer diameter of the small-diameter cylindrical portion 54 may be set to substantially match the inner diameter D3 of the O-ring with no load before being attached.

When the small-diameter cylindrical portion 54 is provided on the side close to the pipe end from the inclined surface 52 having the conical surface shape, the position and posture of the O-ring 2 can be stabilized by both of the inclined surface 52 and the small-diameter cylindrical portion 54 in the third process for adjusting the posture of the O-ring 2, as illustrated by broken lines in FIG. 6. Thus, the stability and efficiency of the O-ring attachment operation are particularly improved.

In the above embodiments, the conical surface is exemplified as the inclined surface having the conical surface shape. However, the inclined surface may be an inclined surface of another mode as long as the inclined surface is formed such that its diameter is reduced toward the pipe end and that the O-ring can move in the axial direction along the inclined surface while the diameter of the O-ring is increased.

For example, the inclined surface may be a conical curved surface that appears as a curve with a curvature radius which continuously changes in cross section including the center axis of the pipe-shaped portion. Alternatively, the inclined surface may be a folded surface (a surface formed by aggregating curved surfaces) that appears as a bent line with a curvature radius changing discontinuously in cross section including the center axis of the pipe-shaped portion. Furthermore, the inclined surface having the conical surface shape may be configured by plural step-shaped surfaces, the diameter of each of which is gradually reduced toward the pipe end.

In addition, the connector member may include portions other than the hollow pipe-shaped portion. As the other portions, a flange portion to prevent excessive insertion of the connector member into the pipe line, and a key portion to prevent erroneous assembly of the connector member can be exemplified.

A specific applicable field in which the connector member is used is not particularly limited. The connector member is applicable to a variety of fields as long as the connector member made of a synthetic resin is applicable for connecting the pipe lines of the pipe line blocks. For example, the connector member according to the embodiments of this disclosure can be used for pipe line blocks for a hydraulic pressure circuit, a refrigerant pipe, a cooling water circulation system, a pressure transmission system, and a flow rate control valve. Further, the connector member is applicable not only to a pipe line of a circuit for transmitting a fluid pressure such as an oil pressure and a hydraulic pressure but also to a pipe line of a circuit for transmitting a gas pressure such as an air pressure. In such a manner the pipe line blocks, which include pipe lines for various types of pressure transmission circuits, can be connected by the connector member according to the embodiments of this disclosure.

The connector member according to the embodiments of this disclosure provides a high industrial applicability since the connector member can be used to connect the pipe lines provided in the pipe line blocks. The technique of this disclosure may be a connector member used for a connection structure of pipe line blocks and a method for manufacturing the same.

In addition, the connector member for connecting pipe line blocks according to the embodiments of this disclosure may be any of first to third connector members for connecting pipe line blocks described below.

The above first connector member for connecting pipe line blocks is a connector member that is molded into a shape having a hollow pipe-shaped portion by injection molding of a synthetic resin and that is used to connect pipe line blocks, in which a ring-shaped seal groove is provided on an outer peripheral surface of the pipe-shaped portion, an O-ring is attached to the seal groove, D2>D3 is satisfied where D2 represents a diameter of a bottom surface of the seal groove and D3 represents an inner diameter of the O-ring with no load before being attached, an outer peripheral surface on a side near the pipe end from the seal groove of the pipe-shaped portion is provided with an inclined surface having a conical surface shape, a diameter of which is reduced toward a pipe end, an inner peripheral surface of the O-ring that is before being attached and is hardly applied with a load can come into contact with the inclined surface having the conical surface shape, and D1<D2 is satisfied where D1 represents an outer diameter at the pipe end of the pipe-shaped portion.

The above second connector member for connecting pipe line blocks is the above first connector member for connecting pipe line blocks in which D1<D3 is satisfied.

The above third connector member for connecting pipe line blocks is the above first connector member for connecting pipe line blocks in which a small-diameter cylindrical portion having a substantially cylindrical outer peripheral surface shape is formed on a pipe end side from the inclined surface having the conical surface shape of the pipe-shaped portion.

In addition, the method for manufacturing a connector member for connecting pipe line blocks of this disclosure is a method for manufacturing a connector member for connecting pipe line blocks to which an O-ring is attached, and may be a method for manufacturing a connector member for connecting pipe line blocks that includes: a first process for forming a connector member by injection molding of a synthetic resin, in which a hollow pipe-shaped portion is provided, a ring-shaped seal groove is provided on an outer peripheral surface of the pipe-shaped portion, and an inclined surface having a conical surface shape, a diameter of which is reduced toward a pipe end, is provided on the outer peripheral surface on a side close to the pipe end from the seal groove of the pipe-shaped portion; a second process for preparing the O-ring; a third process in which an inner peripheral surface of the O-ring comes into contact with the inclined surface having the conical surface shape of the pipe-shaped portion of the connector member and the O-ring assumes a posture orthogonal to a center axis of the pipe-shaped portion; and a fourth process for pushing the O-ring toward the seal groove while the posture of the O-ring with respect to the center axis of the pipe-shaped portion is maintained from the third process, moving the O-ring to the seal groove while a diameter of the O-ring is increased by using the inclined surface, and attaching the O-ring to the seal groove.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector member for connecting pipe line blocks, comprising:
a hollow pipe-shaped portion made of a synthetic resin; and
an O-ring, wherein
the pipe-shaped portion has a ring-shaped seal groove on an outer peripheral surface of the pipe-shaped portion, and an inclined surface having a conical surface shape on a side close to a pipe end from the seal groove on the outer peripheral surface, a diameter of the inclined surface being reduced toward the pipe end,
the O-ring is attached to the seal groove,
D2 representing a diameter of a cylindrical portion defined by a bottom surface of the seal groove and D3 representing an inner diameter of the O-ring with no load satisfy a relationship of D2>D3, and
D1 representing an outer diameter at the pipe end of the pipe-shaped portion and D2 satisfy a relationship of D1<D2.

2. The connector member for connecting pipe line blocks according to claim 1, wherein D1 and D3 satisfy a relationship of D1<D3.

3. The connector member for connecting pipe line blocks according to claim 1, further comprising
a small-diameter cylindrical portion that has a substantially cylindrical outer peripheral surface shape and that is formed on a side close to the pipe end from the inclined surface.

4. A method for manufacturing the connector member for connecting pipe line blocks according to claim 1, comprising:
forming the connector member including the hollow pipe-shaped portion by injection molding of the synthetic resin;
preparing the O-ring;
adjusting a posture of the O-ring by bringing an inner peripheral surface of the O-ring into contact with the inclined surface such that the O-ring is orthogonal to a center axis of the pipe-shaped portion; and
pushing the O-ring toward the seal groove while the posture is maintained, moving the O-ring to the seal groove while a diameter of the O-ring is increased, and attaching the O-ring to the seal groove.

5. A method for manufacturing the connector member for connecting pipe line blocks according to claim 2, comprising:
forming the connector member including the hollow pipe-shaped portion by injection molding of the synthetic resin;
preparing the O-ring;
adjusting a posture of the O-ring by bringing an inner peripheral surface of the O-ring into contact with the inclined surface such that the O-ring is orthogonal to a center axis of the pipe-shaped portion; and
pushing the O-ring toward the seal groove while the posture is maintained, moving the O-ring to the seal groove while a diameter of the O-ring is increased, and attaching the O-ring to the seal groove.

6. A method for manufacturing the connector member for connecting pipe line blocks according to claim 3, comprising:
forming the connector member including the hollow pipe-shaped portion by injection molding of the synthetic resin;
preparing the O-ring;
adjusting a posture of the O-ring by bringing an inner peripheral surface of the O-ring into contact with the inclined surface such that the O-ring is orthogonal to a center axis of the pipe-shaped portion; and
pushing the O-ring toward the seal groove while the posture is maintained, moving the O-ring to the seal groove while a diameter of the O-ring is increased, and attaching the O-ring to the seal groove.

7. A method for manufacturing a connector member for connecting pipe line blocks, comprising:
forming a connector member including a hollow pipe-shaped portion by injection molding of a synthetic resin;
preparing an O-ring, wherein
the pipe-shaped portion has a ring-shaped seal groove on an outer peripheral surface of the pipe-shaped portion, and an inclined surface having a conical surface shape on a side close to a pipe end from the seal groove on the outer peripheral surface, a diameter of the inclined surface being reduced toward the pipe end;
adjusting a posture of the O-ring by bringing an inner peripheral surface of the O-ring into contact with the inclined surface such that the O-ring is orthogonal to a center axis of the pipe-shaped portion; and
pushing the O-ring toward the seal groove while the posture is maintained, moving the O-ring to the seal groove while a diameter of the O-ring is increased, and attaching the O-ring to the seal groove.

8. The method for manufacturing a connector member for connecting pipe line blocks according to claim 7, wherein
D2 representing a diameter of a cylindrical portion defined by a bottom surface of the seal groove and D3 representing an inner diameter of the O-ring with no load satisfy a relationship of D2>D3, and
D1 representing an outer diameter at the pipe end of the pipe-shaped portion and D2 satisfy D1<D2.

9. The method for manufacturing a connector member for connecting pipe line blocks according to claim 8, wherein
D1 and D3 satisfy a relationship of D1<D3.
